(19) United States
(12) Patent Application Publication
(10) Pub. No.: US 2002/0191077 A1
(43) Pub. Date: Dec. 19, 2002

(54) Image forming apparatus

(76) Inventors: Hiroaki Takano, Tokyo (JP); Yoshihiko Suda, Tokyo (JP)

Correspondence Address: CANTOR COLBURN LLP, 55 Griffin Road South, Bloomfield, CT, 06002, US

(21) Appl. No.: 10/152,876

(22) Filed: May 21, 2002

(30) Foreign Application Priority Data
May 28, 2001 (JP) 158086/2001

(51) Int. Cl. H04N 5/253

(52) U.S. Cl. 348/96

(57) ABSTRACT

The present invention relates to an image forming apparatus to obtain a digital image data, comprising: developing device to give a color development to silver halide color photographic light sensitive material and to form a dye image on the light sensitive material; image reading device reading the dye image to obtain a dye image information, converting the dye image information to electronic signals via a image imputing medium and forming a digital image data from the electronic signals; image data processing device to give a image data processing to the digital image data; and identifying device to obtain an identification information of the light sensitive material, wherein an image reading condition in the image reading device is adjusted in accordance with the identification information.

### FIELD OF THE INVENTION

The present invention relates to an image forming apparatus to obtain digital image data, which is provided for functions of development of a silver halide light-sensitive color photographic material, scanning, and image processing.

In more detail, the present invention relates to an image forming apparatus which reads an identification information of said silver halide light-sensitive color photographic material and adjusts reading conditions while reading a dye image utilizing said identification information.

### BACKGROUND OF THE INVENTION

In recent years, light-sensitive photographic materials, utilizing silver halide, have increasingly progressed. At present, it is possible to easily obtain high quality color images. For example, in the system which is commonly called color photography, images are exposed to a color negative film, and image information recorded on said color negative film is printed on color photographic paper after development, whereby color prints are prepared. Recently, the process, as above, has made sophisticated progress and anyone can easily enjoy color photography due to popularization of large-scale centralized color labs which produce a number of color prints under high efficiency, as well as so-called minilabs which are smaller and simpler printer-processors which are installed in shops.

As the principle of commonly employed current color photography, the subtractive color system is utilized for color reproduction. Common color negative films comprise a transparent support having thereon light-sensitive layers comprised of silver halide emulsions which are light-sensitive elements provided with light sensitivity in the blue, green and red regions. Said light-sensitive layers contain so-called color couplers, in combination, which form yellow, magenta, and cyan dyes, each of which color becomes a complimentary color. A color negative film, which has been exposed to images, is developed in a color developer comprising an aromatic primary amine developing agent. During said color development, exposed silver halide grains are developed, or reduced, and each of said dyes is formed through a coupling reaction between each of said couplers and an oxidation product of said developing agent which is simultaneously formed during said development. Subsequently, metallic silver (hereinafter occasionally referred to as “developed silver”) and non-reacted silver halide (hereinafter occasionally referred to as “silver halide”) are removed employing a bleaching and fixing process, respectively, whereby dye images are prepared. A color photographic paper, which is a light-sensitive color material comprising a reflective support having thereon light-sensitive layers having combinations of similar light-sensitive wavelength regions and hues formed by color development to the negative film, is optically exposed through a photographically processed negative film, and subsequently, is subjected to color development, a bleaching and fixing process in the same manner as above, whereby it is possible to obtain color prints comprised of dye images which reproduce original scenes.

On the other hand, a method is known in which an image formed on said color negative film is optically read employing an image scanner; after converting said read information to electric signals, the resultant signals are subjected to image processing to form digitals image data; and the digitals image data is then transferred to another image forming material to form a visible image. When said method is employed, it is possible to obtain digitally produced prints in such a manner that finished prints are obtained by carrying out scanning exposure onto light-sensitive materials such as color photographic paper. In addition, it is also possible to obtain finished prints employing various types of non-silver salt printers such as ink jet printers, sublimation dye printers, and electrophotographic system printers.

Said systems have been widely employed, and making said systems more simple and convenient has been increasingly demanded. First, it is necessary that the compositions and temperature of each of the processing baths which achieve said color development, bleaching, and fixing, is precisely controlled and professional knowledge as well as high-skilled operation is needed. Secondly, these processing solutions contain color developing agents and iron chelate compounds as bleaching agents, which are subjected to environmental regulations for their effluents. As a result, in many cases, special facilities are required for installment of photographic processors. Thirdly, said development takes time, even though said time has been shortened based on recent technical developments. However, it should be pointed out that the current decrease in processing time does not satisfy the demand for still quicker reproduction of recorded images.

Due to said background, a system is increasingly demanded, which provides excellent convenience for customers in such a manner that by constituting a system in which said color developing agent as well as said bleaching agent is not employed, environmental pollution is reduced and limitations for shops, as well as processing time, are also reduced.

Known as component technology (reading and image processing conditions) for constituting systems in which said bleaching agent is not used, are those described below.

Japanese Patent Application No. 10-324496 describes that infrared information (silver halide and developed silver) is read and operations are carried out.

By employing such a method, it is possible to obtain images which are to some extent excellent, even though the desilvering process is eliminated. However, the state of silver halide as well as developed silver, which is utilized as said infrared information, varies depending on the types of light-sensitive photographic materials. Accordingly, adjustment, which is carried out during image data processing, based on the results obtained by reading said infrared information followed by carrying out calculation, exhibits limitations. As a result, depending on the types of light-sensitive materials, when said desilvering process is omitted, the desired images are occasionally not obtained. Thus, additional improvements have been sought.

Known as a system which has decreased said limitations for shops, as well as processing time, is the system described below.

Japanese Patent Publication Open to Public Inspection No. 2001-066707 describes a self-operation apparatus which performs development+scanning+image processing. However, a further decrease in processing time as well as further simplification of the processes is demanded.

Accordingly, the means described below are demanded for an apparatus which obtains digital image data, utilizing said development proceeding to scanning and reading and then proceeding to image processing.

(1) A simple possible development device, which makes it possible to sufficiently obtain reproducible processing characteristics (being sensitometric characteristics)

(2) A reading device, which reads a film having the processing characteristics obtained by (1) above under optimal conditions, and further makes it possible to obtain sufficient exposed image information, and

(3) An image data processing device which makes it possible to obtain digital image data, of desired image quality, from the exposed image information obtained in (1) and (2) above.

The degree of simplification under said development conditions, described in (1) above, is determined depending on the degree of optimization of each of the reading conditions described in (2) above, and the image data processing conditions described in (3) above. Namely, by performing optimal actions during said reading as well as said image data processing, currently it has become possible to expect to carry out simplification during said development. Incidentally, it has been difficult to achieve such simplification which degrades processing characteristics (or sensitometric characteristics).

As methods for identifying film, identification informations in which the shape and the design of film strips themselves as well as of cartridges into which said film strip is placed under light-shielded conditions are utilized. Listed as examples of the specific informations are the three described below.

1. Identification based on the universal commodity code (bar code and Arabic numerals of said bar code) printed on the surface of film cartridges

2. Identification based on trademark designs printed on the surface of film cartridges

3. Identification based on the raster marks (perforations), which are produced by perforating film

These are known as DX Code.

On the surface of said film cartridges, a camera automatic sensing code (CAS) section, a bar code section for machine reading, and a design printed information panel section are formed. Accordingly, it is possible to automatically identify films utilizing those sections except for said camera automatic sensing code (CAS).

Further, an identification code, called a raster pattern, which consists of a plurality of perforations, is formed on films themselves based on a standard. Accordingly, it is possible to identify film strips.

Known as a method which performs the image data processing described in (3) above for each type of negative film is a gradation correction method employing an LUT (a look-up table).

On the other hand, known as a U.S. Patent is the following.

U.S. Pat. No. 6,174,094 describes an image forming apparatus having processes which perform said development proceeding to scanning and reading and then proceeding to image data processing.

Said U.S. Pat. No. 6,174,094 describes that said image forming apparatus comprises functions which reads the DX code of negative film, optimizes said development conditions for each type of negative films, and selects an optimized algorithm for scanned images.

However, said image forming apparatus does not form digital image data while adding optimized reading conditions for each type of negative films to development conditions as well as image data processing conditions.

A conventional exposure amount controlling mechanism is generally known which reads each exposed frame of a negative film strip which has been exposed under different exposure conditions (for example, under or over exposure) and subsequently varies reading conditions.

However, no method is known which reads with respect to each type of negative film strips, or the state of each exposed frame and the identification information of negative film strips in combination, and alters reading conditions such as the intensity of the light source, spectral characteristics, CCD sensitivity, and reading time.

An image forming apparatus is demanded on the market, which exhibits excellent convenience for customers in such a manner that limitations for shops as well as processing time are reduced, while also diminishing environmental pollution. In order to meet such demands, the means, described below, are sought for said image forming apparatus.

(1) A simple development device, which makes it possible to sufficiently obtain reproducible processing characteristics (sensitometric characteristics)

(2) A reading device, which reads, under optimal conditions, film having the processing characteristics obtained employing

(1) above and makes it possible to obtain exposed image information

(3) An image data processing device, which makes it possible to obtain digital image data having desired image quality, utilizing exposed image information obtained in (1) and (2) above

### SUMMARY OF THE INVENTION

Accordingly, an object of the present invention is to realize optimization employing (2) and (3) above, which matches the processing characteristics of each type of negative film described in (1) above, in order to achieve the simplest possible development described in (1) above.

The aforesaid object was achieved employing the structures described below.

[Structure 1]

An image forming apparatus to obtain a digital image data, comprising:

developing device to give a color development to silver halide color photographic light sensitive material and to form a dye image on the light sensitive material;

image reading device reading the dye image to obtain a dye image information, converting the dye image information to electronic signals via a image imputing medium and forming a digital image data from the electronic signals;

image data processing device to give a image data processing to the digital image data; and identifying device to obtain an identification information of the light sensitive material,

wherein an image reading condition in the image reading device is adjusted in accordance with the identification information.

[Structure 2]

The image forming apparatus of Structure 1, wherein a developing condition in the developing device is further adjusted in accordance with the identification information.

[Structure 3]

The image forming apparatus of Structure 2, wherein an image data processing condition is further adjusted in accordance with the identification information.

Specifically, the present invention provides the following effects.

According to the present invention described in Structure 1, in an image forming apparatus comprising development, reading, and image data processing devices, it is possible to set reading conditions which are optimized for differences in processability (being the state of the negative film strips) of each type of negative film which are caused by the simplification of photographic processing conditions, specifically caused by thermal development and non-desilvering process, whereby it is possible to obtain digital image data of high image quality.

According to the present invention described in Structure 2, in an image forming apparatus comprising development, reading, and image data processing devices, it is possible to set development conditions, as well as reading conditions, which are optimized for differences in processability (being the state of the negative film strips) of each type of negative film which are caused by the simplification of photographic processing conditions, specifically caused by thermal development and the non-desilvering process, whereby it is possible to obtain digital image data of high image quality.

According to the present invention described in Structure 3, in an image forming apparatus comprising development, reading, and image data processing devices, it is possible to set development conditions, reading conditions, and image data processing conditions which are optimized for differences in processability (being the state of the negative film strips) of each type of negative film which are caused by the simplification of photographic processing conditions, specifically caused by thermal development and the non-desilvering process, whereby it is possible to obtain digital image data of high image quality.

### BRIEF DESCRIPTION OF THE DRAWINGS

FIG. 1 is a flow diagram showing one example of processing steps employing the image forming apparatus according to the present invention.

FIG. 2 is a view showing the structure of one example of the image forming apparatus according to the present invention.

### DETAILED DESCRIPTION OF THE INVENTION

The present invention will now be detailed.

Silver halide light-sensitive color photographic materials (hereinafter occasionally referred to as negative film, film, and light-sensitive materials), as described in the present invention, refer to, for example, color negative film such as the Century Series, manufactured by Konica Corporation, which is known as conventional photographic film. Further, in the present invention, said color photographic materials may be a color negative film which is constituted so as to be suitable for film scanner reading while not making the premise for preparing photographic prints which are produced by image exposure on photographic paper, employing an analog printer employing said conventional film. As such negative film, for example, Japanese Patent Publication Open to Public Inspection No. 2000-310840 describes a negative film which has a luminance-recording light-sensitive layer for extracting luminance information as well as color information of digital images, and a preferred negative film which has an independent light-sensitive layer which records color information.

Image input medium in the present invention are not particularly limited as long as they have a photoelectric conversion function which converts a dye image to electric signals. However, an aggregate (CCD) of an imaging device (pixel) having a photoelectric conversion function is preferably employed. Said CCD includes a linear shape in which said imaging devices are one-dimensionally arranged and an area type in which said imaging devices are two-dimensionally arranged. However, in the present invention, from the viewpoint of omitting transport mechanisms as well as shortening reading time, said area-shaped CCD is preferably employed.

The development device used in the present invention are not particularly limited as long as they are device having a mechanism to carry out color development. However, said apparatus preferably comprises a film transport mechanism as well as a temperature controlling mechanism. Employed as said mechanisms to carry out color development may be those which utilize methods, known in the art, such as liquid development as well as thermal development (including those using pastes as well as processing sheets). However, in order to reduce dimensions of said apparatus and to reduce processing effluent, thermal development is preferably employed.

In the present invention, from the viewpoint of a further decrease in dimensions of the apparatus, a decrease in the time necessary for the processing steps, and a decrease in pollution due to the processing effluents, it is preferable that at least one part of the desilvering processes (a bleaching process, a fixing process, and a bleach fixing process) is not carried out or the processing time is thereby shortened. It is more preferable that the desilvering process is not carried out at all. Namely, it is preferable that scanner reading is carried out for the state in which some or all of the silver incorporated in a light-sensitive material remains after development. It is possible to decrease effects of processing effluents to the environment by recovering negative film in which some or all silver incorporated in said film without returning said film to customer.

Further, in the present invention, in order to identify the types of color negative film (identification information of color negative film) before development, it is more preferable that an exposed frame area excluding the end part which has been subjected to a latent image bar code is selectively developed, because it is possible to decrease the amount of processing solutions and to minimize the adhesion of processing solutions to a film transport section.

Further, a preferred embodiment is that a single developer cartridge should be used for each color negative film roll and be replaced after every development. Another preferred embodiment is that a plurality of said developer cartridges for each of 12-exposure, 24-exposure, and 36-exposure film rolls be prepared, and selected and then employed based on information of the types (the number of exposed frames) of color negative film strips.

Development conditions in the present invention refer to conditions during said color development, and are not particularly limited. However, when said development conditions are adjusted, it is preferable that at least one, either development time, temperature, pH of the developer, type of the developer or the amount of the developer be adjusted.

In order to enhance the S/N ratio during reading employing a scanner, it is preferable to decrease the density (Dmin) of unexposed areas and to set γ on the characteristic curve, expressed by Log E versus density of a color-sensitive layer (specifically a blue-sensitive layer), at a lower value. In order to achieve this, it is preferable that said development conditions are set for each type of color negative film.

Specifically, when thermal development is carried out, development conditions refer to development time or development temperature. By adjusting the heating time or the heating time as well as the temperature, the processability of each type of color negative film is improved.

The image reading devices in the present invention are not particularly limited as long as they are mechanisms capable of obtaining image data through converting dye images formed by said color development into electric signals. It is possible to employ devices (scanners) known in the art. Said image reading device is preferably a device comprising a light source, a color separation mechanism (not required when red (R), green (G), and blue (B) light sources are employed) provided with R, G, and B filters, said image input medium, and a film transport mechanism (a scanning mechanism when said image input medium is a linear type CCD).

The image reading conditions of the present invention refer to conditions of said image reading device during image reading, and are not particularly limited. However, it is preferable that when said image reading conditions are adjusted, at least one of the following parameters is adjusted: the intensity of said light source, the spectral characteristic of B, G, and R filters, the sensitivity of said image input medium, or the reading time.

Further, in the present invention, it is particularly preferable to set the intensity of said light source, the spectral characteristics of R, G, and B filters, the sensitivity of image input media, and the reading time, corresponding to the density increment proportional to the amount of residual silver, which is estimated based on the identification information of negative film.

The image data processing devices of the present invention are not particularly limited as long as they are mechanisms capable of processing and adjusting image data obtained by said image reading device. Said image data processing device preferably are software having functions to adjust image quality such as gradation, color (hue and saturation), sharpness, and graininess, as well as a device having a CPU which executes said functions.

The image data processing conditions, as described in the present invention, refer to set conditions during image processing in said image data processing device which are employed to improve each of several characteristics related to image quality such as the gradation, graininess, sharpness and color reproduction, and none of which are not particularly limited. However, when said image data processing conditions are adjusted, it is specifically preferable that a process is carried out which corrects color contamination (cross-talk) among R, G, and B.

As described above, in the present invention, from the viewpoint of simplification of the apparatus, as well as a decrease in processing time, it is preferable that in photographic processing, color development is carried out and desilvering processes (being a bleaching process, a fixing process or a bleach-fixing process; are omitted. However, when said desilvering processes are omitted, saturation decreases due the residual silver. Mainly assumed as the factor are two points. One is a decrease in color density difference due to developed silver, and the other is due to the fact described below. The film density of a component (for example a yellow dye image) in the shorter wavelength region increases and consequently higher intensity of light is required for reading. As a result, components (for example, a magenta dye image as well as a cyan dye image) tend to be contaminated. Accordingly, when said desilvering processes are omitted, in order to correct the decrease in saturation due to the resultant residual silver, it is particularly preferable to carry out processing to correct color contamination (cross-talk) among R, G, and B.

It is possible to carry out processing which corrects said color contamination among R, G, and B by adjusting parameters “a” to “i” of color contamination operation based on General Formula described below.

General Formula of contamination operation

$$( \begin{matrix}{R}^{′} \\ {G}^{′} \\ {B}^{′}\end{matrix} ) = ( \begin{matrix}abc \\ def \\ ghi\end{matrix} ) ( \begin{matrix}R \\ G \\ B\end{matrix} )$$

$$R , G , B : input$$

$${R}^{′} , {G}^{′} , {B}^{′} : output$$

The color contamination (cross-talk) operation, as described as above, refers to a decrease in unnecessary components employing image processing operations because the separation of Y (yellow), M (magenta), and C (cyan) does not reach 100 percent due to the light source, and the spectral characteristics used for color separation during reading color negative film strips employing a scanner (photoelectric conversion).

As the adjustment of image data processing conditions in the aforesaid image data processing, it is also preferable to divide said image data into luminance information and color information, and then to apply different image data processing (for example, a sharpness enhancing process only to the luminance component) to each kind of information, and also to adjust the processing magnitude (being a set value).

Further, as described in Japanese Patent Publication Open to Public Inspection No. 2000-209440, after applying said sharpness enhancing process, processing steps such as the application of a smoothening process, and the processing magnitude (being a set value) are also preferable as the processing conditions of the present invention.

In the present invention, a reading device, as well as an image data processing device, may be set for each type of negative film whether operation is carried out or not, through reading infrared information (silver halide and developed silver) as described in Japanese Patent Application No. 10-324496, and reading conditions related to said system and image data processing conditions may be set.

The image forming apparatus according to the present invention comprises said development device, image reading device, and image data processing device, and is capable of obtaining digital image data within the shortest time by continuously operating these devices.

Said image forming apparatus in the present invention is preferably constituted so as to be a self-operation apparatus, as described in Japanese Patent Publication Open to Public Inspection No. 2001-066707.

The device for obtaining the identification information of the film, as described in the present invention, refers to the means to identify film types and the shape and design of cartridge packaging of said film in a light shielding state in order to identify the type of processed light-sensitive materials. Listed as preferred examples of such device are devices comprising a reading sensor section capable of reading at least one of the aforesaid DX codes as well as a code analysis processing section.

The development, as described in the present invention, is preferably thermal development. For example, it is preferable that the following method be employed. An exposed silver halide light-sensitive photographic material, comprising a silver halide emulsion layer, is faced with a processing member via an image forming water-based medium and is subjected to development, whereby an image is formed on said silver halide light-sensitive material. During said process, it is preferable that said image forming water-based medium comprises at least one of color developing agents and/or color developing agent precursors.

It is preferable that the photographic processing of the present invention satisfies at least one of the following items.

(1) The viscosity of the aforesaid image forming water-based medium should be from 10.1 to 1,500 cp at 25° C.

(2) The aforesaid color developing agents and/or color developing agent precursors should be at least one of the compounds which release or form the compounds represented by General Formula (1), described below, in the presence of the compounds represented by General Formula (1), and alkalis.

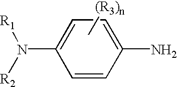

wherein R₁ and R₂ each represents an alkyl group, an aryl group, and a heterocylic group and R₁ and R₂ can be joined together to form a ring; R₃ represents an alkyl group, an aryl group and a heterocyclic group and different R₃ can be joined together to from a ring; and n represents an integer of 0 to 4.

(3) The aforesaid silver halide light-sensitive photographic material should substantially comprise neither color developing agents nor color developing agent precursors.

(4) The aforesaid processing member should substantially comprise neither color developing agents nor color developing agent precursors.

(5) The aforesaid image forming water-based medium should comprise basic precursors.

(6) The aforesaid processing member should comprise sparingly water-soluble metal compounds and the aforesaid image forming water-based medium should comprise complex forming compounds.

(7) The aforesaid processing member should comprise complex forming compounds and the aforesaid image forming water-based medium should comprise sparingly water-soluble metal compounds.

(8) Gelatin weight “a” (g/m²) incorporated in the aforesaid silver halide light-sensitive photographic material, gelatin weight “b” (g/m²) incorporated in the aforesaid processing member, and amount “c” (mmol/m²) of the aforesaid complex forming compound, which is incorporated in the aforesaid processing member or is provided from the aforesaid image forming water-based medium, should satisfy the relationship:

1≦c/(a+b)≦10.

(9) Amount “c” (mmol/m²) of the aforesaid complex forming compound, which is incorporated in the aforesaid processing member or is provided from the aforesaid image forming water-based medium, and amount “d” (mmol/m²) of the aforesaid sparingly water-soluble metal compound, which is incorporated in the aforesaid processing member or is provided from the aforesaid image forming water-base medium, should satisfy the relationship:

0.2≦d/c≦6.

(10) Gelatin weight “a” (g/m²) incorporated in the aforesaid silver halide light-sensitive photographic material, gelatin weight “b” (g/m²) incorporated in the aforesaid processing member, and water amount “e” (g/m²) provided from the aforesaid image forming water-based medium should satisfy the relationship:

1≦e/(a+b)≦6.

(11) “f” (mmol/m²) of a color developing agent and a color developing agent precursor provided from the aforesaid image forming water-based medium should satisfy the relationship:

3≦f≦40.

(12) After providing the aforesaid image forming water-based medium to the aforesaid processing member, the resultant processing member should be faced with the aforesaid silver halide light-sensitive photographic material.

(b 13) The aforesaid development process should be a thermal heated development one (being a thermal development process) from 43 to 95° C.

Further, above items (1) through (13) will now be detailed.

First, an image forming water-based medium will be described.

The image forming water-based medium comprises at least one type of color developing agents and/or color developing agent precursors.

The color developing agents, as described herein, refer to compounds capable of forming dye images in such a manner that the oxidization product of said color developing agent, which is formed upon developing silver halide having latent images, reacts with couplers. Specific compounds of said color developing agents include, for example, p-phenylenediamine based developing agents such as (C-1) thorough (C-16) described on pages 26 through 31 of Japanese Patent Application No. 2-203169, (1) through (8) on pages 29 through 31 of Japanese Patent Publication Open to Public Inspection No.61-289350, (1) through (62) on pages 5 through 9 of Japanese Patent Publication Open to Public Inspection No. 3-246543, exemplified compounds (C-1) and (C-3) described in Japanese Patent Application No. 2-203169, exemplified compound (2) described in Japanese Patent Publication Open to Public Inspection No. 61-289350, exemplified compound (1) described in Japanese Patent Publication Open to Public Inspection No. 3-246543, compounds described in General Formulas I through V of Japanese Patent Application No 11-339858; and sulfoneamidophenol based color developing agents, sulfoneamidoaniline based color developing agents, and hydrazine based color developing agents descried in General Formulas I through V of Japanese Patent Application 11-339858. Further, p-phenylenediamine based color developing agent precursors may be employed which are described in Japanese Patent Publication Open to Public Inspection Nos. 5-241305 and 11-167185, and described in General Formulas (1) through (6) of Japanese Patent application No. 11-358973.

Of these, p-phenylenediamine based color developing agents are preferably employed. Compounds having a hydrophilic group, such as a hydroxyl group and a sulfonyl group, can be more preferably employed.

The p-phenylenediamine based compounds, which are preferably employed in the present invention, can be represented by General Formula (1) described below.

General Formula (1)

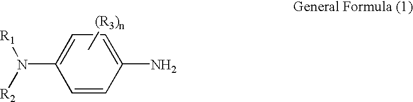

wherein R₁ and R₂ each represents an alkyl group, an aryl group, and a heterocylic group, and R₁ and R₂ can be joined together to form a ring; R₃ represents an alkyl group, an aryl group and a heterocyclic group and different R₃ can be joined together to from a ring; and n represents an integer of 0 to 4.

On the other hand, color developing agent precursors employed in the present invention are preferably at least one of the type of compounds represented by the aforesaid General Formula (1) which release or form the compounds in the presence of alkalis.

Compounds, which release or form the compounds represented by aforesaid General Formula (1) are preferably selected from the compounds represented by General Formula (1B) described below.

General Formula (1B)

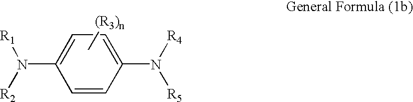

wherein R₁ and R₂ each represents an alkyl group, an aryl group, and a heterocyclic group, and R₁ and R₂ can be joined together to form a ring; R₃ represents an alkyl group, an aryl group and a heterocyclic group and different R₃ can be joined together to from a ring; R₄ and R₅ each represents a hydrogen atom (however, R₄ and R₅ do not represent a hydrogen atom at the same time) or a group which can be converted to a hydrogen atom by hydrolysis or a nucleophilic reaction, and R₄ and R₅ can be joined together to form a ring; and n represents an integer of 0 to 4.

Listed as specific compounds of such color developing agent precursors are compounds 1-1 through 1-18, 2-1 through 2-22, 3-1 through 3-33, 4-1 through 4-8, and 5-1 through 5-8 described in Japanese Patent Application No. 2000-312253.

The viscosity of image forming water-based medium is preferably from 10.1 to 15,000 centipoises (cp) at 25° C. A viscosity less than or equal to the lower limit is not preferred because uneven development tends to occur. On the other hand, a viscosity more than or equal to the upper limit is also not preferred because problems such as a decrease in developed color density tend to occur, due to hindrance of material diffusion. Said viscosity is more preferably in the range of 15 to 3,000 centipoises, and is further more preferably in the range of 20 to 1,000 centipoises.

Methods for controlling said viscosity include, for example, a method in which water-soluble polymers are incorporated in a processing solution within a range which does not adversely affect photographic processing performance, a method in which salt concentration is controlled within the range which does not adversely affect processing performance, and a method in which hydrophilic solvents are incorporated in an amount which does not adversely affect processing performance. However, methods for controlling said viscosity are not limited to those described above. Listed as water-soluble polymers usable in the present invention are, for example, vinyl polymers and derivatives thereof such as polyvinyl alcohols, polyvinyl pyrrolidones, polyvinylpyridinium halides, and various types of modified polyvinyl alcohols; polymers comprised of an acryl group such as polyacrylamide, polydimethylacrylamide, polydimethylaminoacrylate, sodium polyacrylate, copolymer salts of acrylic acid-methacrylic acid, sodium polymethacrylate, and copolymer salts of acrylic acid-vinyl alcohol; natural polymer materials and derivatives thereof such as starch, oxidized starch, carboxyl starch, dialdehyde starch, cationic starch, dextrin, sodium alginate, gum Arabic, casein, Pullulan, dextran, methyl cellulose, ethyl cellulose, carboxymethyl cellulose, and hydroxypropyl cellulose; and synthetic polymers such as polyethylene glycol, polypropylene glycol, polyvinyl ether, polyglycerin, copolymers of alkyl maleate-vinyl ether, and polyethyleneimine.

It is preferable that the amount of color developing agents and color developing agent precursors, which are provided from the aforesaid image forming water-base medium, is specified. Namely, the total amount “f” (mmol/m²) of color developing agents and color developing agent precursors, provided from the aforesaid image forming water-based medium, is preferably in the range of 3≦f≦40. By adjusting “f” to said range, it is possible to obtain sufficient color development density, to decrease fog formation, and to minimize degradation of the storage stability of the aforesaid image forming water-based medium due to the fact that it is unnecessary to dissolve color developing agents in said image forming water-based medium at high concentration.

Said image forming water-based medium may be comprised of only one type of liquid or may be employed by blending at least two types of liquid portions. When at least two types of liquid potions are blended, blending may be carried out on the surface of the light-sensitive material or the processing member described below. Alternately, blending may be carried out just prior to use, and the blending may be provided to either said light-sensitive material or said processing member. From the viewpoint of simplification of the structure of the processing apparatus as well as uniform processing, said image forming water-base medium is preferably comprised of only one type of liquid.

The processing member will now be described.

Said processing member, as described herein, refers to a sheet member which is employed to carry out color development while faced with said light-sensitive material in the presence of said image forming water-based medium, and a sheet processing member which comprises, if desired, a support comprised of materials employed in conventional light-sensitive materials having thereon specified compounds.

Employed as supports of said processing member are those employed as supports of conventional light-sensitive materials, and include, for example, polyolefin film such as polyethylene film, polystyrene film, polycarbonate film, cellulose derivative film such as cellulose acetate film, polyester film such as polyethylene terephthalate film and polyethylene naphthalate film, polyester film in which substituents such as a polar group are introduced, and polyimide film which is obtained by allowing pyromellitic acid or anhydrides thereof to react with diamine.

When it is assumed that as described in the present invention, without substantially removing silver as well as silver compounds from a silver halide light-sensitive photographic material, and further without peeling off a processing member, images are read, it is preferable that the optical density, for visible light, of the support employed in said processing member is as low as possible.

Employed as binders, which are applied onto the processing member, may be the same ones as those commonly employed in light-sensitive materials. However, those which are hydrophilic are preferred. Listed as such examples are those described in Research Disclosures descried below and those described on pages (71) through (75) of Japanese Patent Publication Open to Public Inspection No. 64-13546. When coated, hydrophilic binders which form a transparent or translucent coating are preferred, and those which form transparent coatings are more preferred. Specifically listed are, for example, natural compounds such as proteins including gelatin and gelatin derivatives, cellulose derivatives, and polysaccharides including starch, gum Arabic, dextran, Pullulan, and carrageenan, as well as synthetic polymer compounds such as polyvinyl alcohol, polyvinyl pyrrolidone, and acrylamide polymers. Further employed are high water-absorbing polymers described in U.S. Pat. No. 4,960,681 and Japanese Patent Publication Open to Public Inspection No. 62-245260, being namely homopolymers of vinyl monomers having —COOM or —SO₃M (wherein M represents a hydrogen atom or an alkali metal) or copolymers of said vinyl monomers or said vinyl monomer with other vinyl monomers (for example, sodium methacrylate, ammonium methacrylate, and potassium acrylate). These binders may be employed in combination of at least two types. When employed in such combination, a combination with other binders is preferred. Further, according to various purposes, gelatin may be selected from limed gelatin, acid process gelatin and so-called delimed gelatin in which the content of calcium is decreased, and is also preferably employed in combination.

Basic precursors employed in the present invention will now be described.

Basic precursors as an alkali providing source are employed. The basic precursors, as described herein, refer to compounds which release alkali through reaction. Listed as those may be, for example, base generating agents described in Japanese Patent Publication Open to Public Inspection Nos. 56-13745 and 57-132332; compounds which release or form basic components when heated, described in British Patent No. 998,949; U.S. Pat. Nos. 3,220,846 and 3,523,795; Japanese Patent Publication Open to Public Inspection Nos. 50-22625, 59-168440, 59-168441, 59-180537, 60-237443, 61-32844, 61-36743, 61-52639, 61-51139, 61-51140, 61-52638, 61-53631, 61-53634, 61-53635, 61-53636, 61-53637, 61-53638, 61-53639, 61-53640, 61-55644, 61-55645, 61-55646, 61-219950, and 61-251840; and combinations of sparingly water-soluble basic metal with alkali releasing compounds which undergo a complex forming reaction with metal ions composing said basic metal compound employing water as a medium, which are described in European Patent Publication Open to Public Inspection No. 210,660 and U.S. Pat. No. 4,740,445.

As basic precursors, it is particularly preferred to employ combinations of a sparingly water-soluble basic metal compound and an alkali releasing compound which undergoes complex forming reaction with metal ions composing said basic metal compound, employing water as a medium.

Either the aforesaid “sparingly water-soluble metal compounds (hereinafter occasionally referred to as sparingly soluble metal compounds)”, or the aforesaid “alkali releasing compounds (hereinafter occasionally referred to as complex forming compounds) which undergo complex forming reaction with metal ions composing basic metal compounds, employing water as a medium, are defined as basic precursors.

Employed as compounds which form complex compounds with metal ions, composing basic metal compounds, may be, for example, aminocarboxylic acids such as ethylenediaminetetraacetic acid, nitrilotriacetic acid, diethylenetriaminepentaacetic acid or salts thereof; aminosulfonic acids or salts thereof; pyridylcarboxylic acids such as 2-picolinic acid, pyridine-2,6-dicarboxylic acid, and 5-ethyl-2-picolinic acid or salts thereof; and iminodiacetic acid such as α-picoryliminodiacetic acid or salts thereof. Said complex forming compounds are preferably employed in the form of salts which are obtained by neutralizing those with organic bases such as guanidine or alkali metals such as sodium.

Listed as examples of sparingly water-soluble basic metal compounds are metal oxides, metal hydroxides, metal carbonates, metal silicates, metal nitrates, and metal aluminates which exhibit water solubility of less than or equal to 0.5. Of these, metal compounds represented by General Formula (M), described below, are preferably employed.

General Formula (M) ZgXh

wherein Z represents a metal other than alkali metals; X represents an oxide ion, a hydroxide ion, a carbonate ion, a phosphate ion, a silicate ion, a nitrate ion, or an aluminate ion; and g and h each represents an integer which makes it possible to balance the atomic valence of Z and X. The metal compounds represented by General Formula (M) may have crystallization water and may form a double salt.

In General Formula (M), listed as Z are metal ions such as Zn²⁺, Co²⁺, Ni²⁺, Mn²⁺, Cu²⁺, Hg²⁺, Zr²⁺, Ba²⁺, Sr²⁺, and Ca²⁺. Of these, Zn²⁺ is preferred. Listed as X are an oxide ion, a hydroxide ion, a phosphate ion, and a carbonate-ion.

Listed as examples of specific compounds may be Zn(OH)₂, ZnO, Co(OH)₂, CoO, Ni(OH)₂, Cu(OH)₂, Fe(OH)₂, Mn(OH)₃, BaCO₃, Sr(CO)₃, CaCO₃, basic zinc carbonate, basic cobalt carbonate, basic nickel carbonate, and basic bismuth carbonate. Of these, compounds are preferred which do not color a dispersion when dispersed in a dispersion medium containing water.

An incorporation method of said basic precursors is that at least one type of precursors is incorporated in the aforesaid image forming water-based medium. When a combination of the aforesaid complex forming compounds and sparingly soluble metal compounds is provided employing said image forming water-based medium, a method is preferred in which as noted above, said image forming water-based medium is divided into at least two portions, and said complex forming compounds and said sparingly soluble metal compounds are separated and incorporated into each of the divided portions.

In order to efficiently achieve the purpose of the present invention, either of the constitutions is effective in which complex forming compounds are incorporated in the aforesaid image forming water-based medium and sparingly soluble metal compounds are incorporated in the aforesaid processing member, or said sparingly soluble metal compounds are incorporated in the aforesaid image forming water-based medium and complex forming compounds are incorporated in the aforesaid processing member. In such a case, for example, when the constitution is such that sparingly soluble metal compounds are incorporated in said processing member and said complex forming compounds are incorporated in said image forming water-based medium, it is preferable that said complex forming compounds are not substantially incorporated in said processing member and said sparingly soluble metal compounds are not substantially incorporated in said image forming water-based medium.

It is preferable to adjust the quantitative relationship between the total amount of gelatin of the silver halide light-sensitive photographic material and the aforesaid processing member, which are employed in the image forming method of the present invention, and the aforesaid complex forming compounds, and further, the quantitative ratio of the aforesaid complex forming compounds to the aforesaid sparingly soluble metal compounds. Specifically, when “a” (g/cm²) represents the weight of gelatin incorporated in the aforesaid light-sensitive material, “b” (g/cm²) represents the weight of gelatin incorporated in the aforesaid processing member, and “c” (g/cm²) represents the weight of said complex forming compounds incorporated in the aforesaid processing member or provided from the aforesaid image forming water-based medium, the relationship of 1≦c/(a+b)≦10 is to be satisfied. Further, when “d” (g/m²) represents the weight of sparingly soluble compound incorporated in the aforesaid processing member or provided from the aforesaid image forming water-based medium, the relationship of 0.2≦d/c≦6 is to be satisfied.

Since gelatin exhibits a buffer action against pH, in order to secure a sufficient amount of alkalis, it is critical to adjust the amount of gelatin as well as complex forming compounds, and further, the amount of complex forming compounds as well as sparingly soluble compounds. On the other hand, complex forming compounds, even though depending on the types, exhibit some retarding action against development of silver halide. Said retarding action does not cause any significant problems for silver halide emulsions, having high develop ability, which are employed for appreciation light sensitive materials. On the other hand, said action adversely affects silver halide emulsions having a relatively low developability and silver iodide at a high content ratio, which are employed for image capturing such as color negative films. From this viewpoint, it is critical to adjust the aforesaid quantitative ratio.

By providing color developing agents and/or precursors thereof from the pH specified image forming water-based medium, it becomes possible to consistently provide high density dye images and it also becomes possible to process widely employed light-sensitive materials such as color negative film. Accordingly, it is preferable that light-sensitive materials comprise substantially neither color developing agents nor color developing agent precursors. Further, it is preferable that the aforesaid processing member substantially comprises neither color developing agents nor color developing agent precursors. By substantially excluding color developing agents as well as color developing agent precursors from light-sensitive materials, storage stability of light-sensitive materials and the processing member is enhanced, whereby it is possible to obtain consistent dye images at all times.

It is also preferable to control the water amount provided from the aforesaid image forming water-based medium. As noted above, when “a” (g/m²) represents the weight of gelatin incorporated in the light-sensitive material, “b” (g/m²) represents the weight of gelatin incorporated in the processing member, and “e” (g/m²) represents the weight of water provided from the aforesaid image forming water-based medium, the range, which satisfies the relationship of 1≦e/(a+b)≦6, is effective. When the weight of water is less than the lower limit, color development reaction does not proceed down to the lowermost layer of the light-sensitive material. On the other hand, when the weight of water exceeds the upper limit, the image forming water-based medium overflows from the space between the light-sensitive material and the processing member to stain the interior of the processor, and further, problems such as uneven development occasionally occur.

The image forming water-based medium may be provided to the processing member, which is subsequently faced with the light-sensitive material. Alternately, the image forming water-based medium may be provided to the light-sensitive material which is subsequently faced with the processing member. However, a system is more effective in which the image forming water-based medium is provided to the processing member, which is subsequently faced with the light-sensitive material.

Other additives, which may be incorporated in the image forming water-based medium and/or the processing member, will now be described.

Other than the aforesaid color developing agents, basic precursors, and retarding agents, solubilizing agents of color developing agents, preservatives, and wetting agents may be incorporated in the image forming water-based medium. Listed as solubilizing agents of color developing agents are triethanolamine, polyethylene glycols, and p-toluenesulfonic acid described in Japanese Patent Application No. 7-10769. Listed as preservatives are sodium sulfite, hydroxylamine, and hydroxylamines described in items 9 through 13 of Japanese Patent Publication Open to Public Inspection No. 8-19924. Listed as wetting agents may be polyhydric alcohols such as propylene glycol, glycerin, and sorbitol.

Surface active agents are preferably incorporated in the image forming water-based medium as a coating aid when said water-based medium is applied onto the light-sensitive material or the processing member, and also in the processing member as a coating aid when the binder layer is applied. Said surface agents employed are not particularly limited, and surface active agents as well as coating aids, which are commonly employed for preparing light-sensitive materials, may be employed.

Employed as systems for providing the image forming water-based medium are spraying systems via atmosphere and coating systems. Listed as spraying systems are a system which ejects liquid droplets utilizing vibration of a piezoelectric element (for example, a piezo type ink jet head), a system which ejects liquid droplets employing a thermal head utilizing bumping, and a spray system which sprays liquid utilizing air pressure or liquid pressure. The coating system, as described herein, refers to the supply of a definite amount of the image forming water-based medium onto the surface of the light-sensitive material or the processing member, utilizing any of several so-called coating systems. A method is not included in which the light-sensitive material is immersed into the tank filled with the image forming water-based medium whereby components penetrate into the light-sensitive material employing diffusion from a bulk liquid. Processing liquid supplying means include a method in which liquid is applied via a means such as rollers, and a method in which liquid is directly supplied, as in curtain coating.

Specifically listed are an air doctor coater, a blade coater, a rod coater, a knife coater, a squeeze coater, an impregnation coater, a reverse roller coater, a transfer roller coater, a curtain coater, a double roller coater, slide hopper coating, a gravure coater, a kiss roll coater; a bead coater, a spray coater, a calender coater, and an extrusion coater. Listed as particularly preferred systems are a squeeze coater, a gravure coater, an impregnation coater, a bead coater, and a blade coater.

In the present invention, it is preferable that processing time be shortened while performing thermal development. As said thermal development conditions, it is effective that thermal development is carried out at a temperature between 45 and 95° C. Said temperature is preferably in the range of 55 to 95° C.

Listed as a means to heat light-sensitive materials are a heat conduction heating means in which a light-sensitive material comes into contact with a heating drum or a heating belt whereby heating is carried out employing heat conduction, a convection heating means in which heating is carried out employing convection by a dryer, and a radiation heating means in which heating is carried out employing radiation such as infrared rays and high frequency electromagnetic waves. In the case of conduction heating, in order to minimize adverse effect onto the processed light-sensitive material, a heating source is preferably brought into contact with the opposite side of the processing member.

In the present invention, after the color development process is finished employing the aforesaid image forming method and subsequently, after reading is finished employing an image sensor, a development terminating process may or may not be carried out. The development terminating process, as described herein, refers to a process which provides, for example, acids to said light-sensitive material, a process which provides development retarders to said light-sensitive material, a process which provides compounds capable of deactivating color developing agents to said light-sensitive material, and a process which provides compounds capable of oxidizing developed silver to said light-sensitive material.

When image information of a light-sensitive member, which has been developed, is read, a method is preferably employed in which light in the wavelength region which can be absorbed by each of at least three dyes is subjected to total reflection on the surface or slit-scanning, and the light amount of the resulting reflection light or transmission light is determined. In such a case, diffuse light rather than parallel light is more preferably employed because it is possible to remove information of matting agents and ablation on the film. Further, a semiconductor image sensor (the aforesaid area type CCD or CCD line sensor) is preferably employed in the light receiving section.

In the present invention, employing the aforesaid image forming method, silver as well as silver compounds (including silver halide) is not removed from the aforesaid light-sensitive martial which has been subjected to color development process. Namely, the resulting images are read without carrying out a so-called bleach or fixing process. In addition, it is also effective to read image information without peeling the processing member, which has been employed during the color development process, from the aforesaid light-sensitive material after the color development process.

### EXAMPLES

The present invention will now be described with reference to specific examples. However, the present invention is not limited to these embodiments.

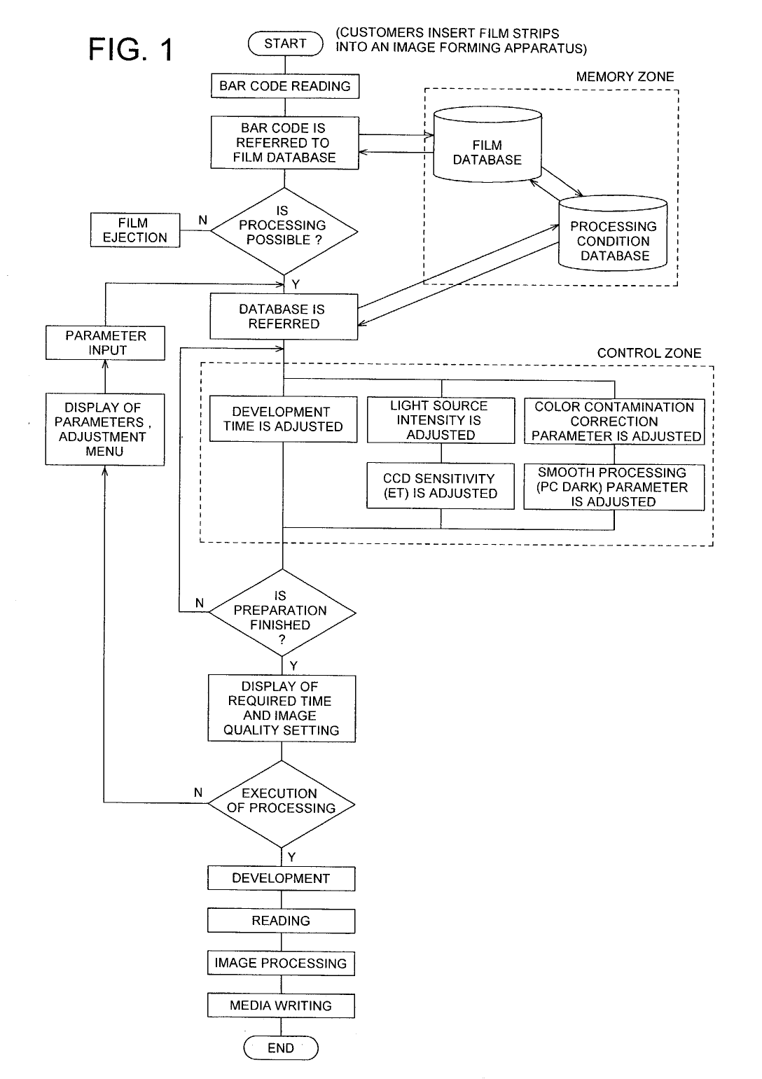

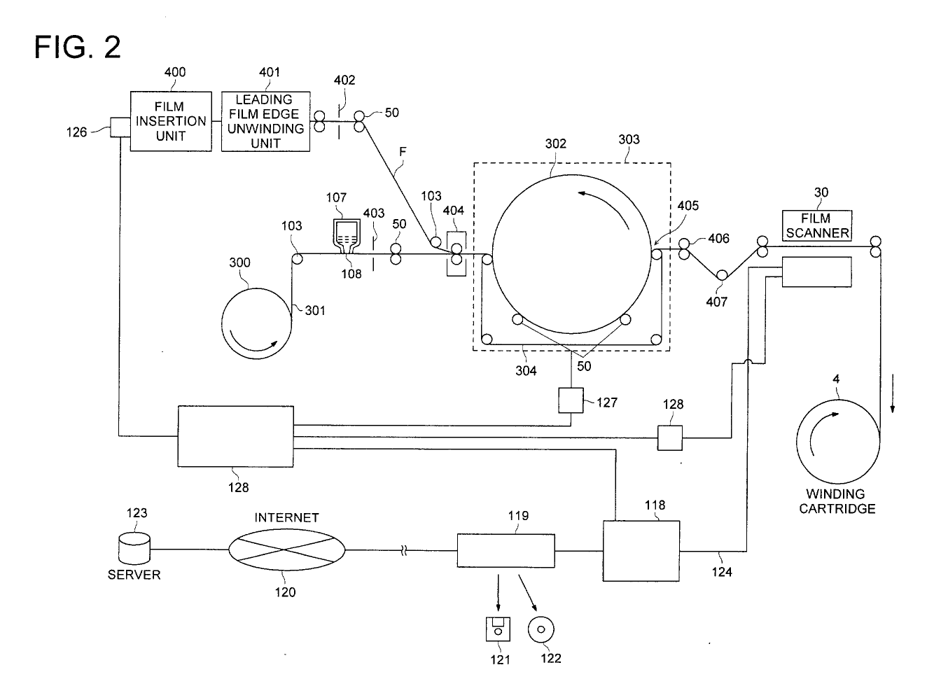

FIG. 1 is a flow diagram showing one example of processing steps employing the image forming apparatus according to the present invention. FIG. 2 is a view explaining the structure of one example of the image forming apparatus according to the present invention.

First, based on FIG. 1, one example of a processing step will now be described.

Processing is allowed to start in such a manner that an operator inserts film strips or rolls (being light-sensitive materials) into a film insertion unit of the image forming apparatus.

Each of film information bar codes of inserted film strips or rolls is read. Subsequently, the read bar code is cross-checked referring to information in the film database.

When it is found that processing is impossible based on the results of the reference to film database, the resultant film is ejected from the image forming apparatus.

As a result of the reference, when processing conditions are recorded in said database and processing is determined to be possible, the resultant film strips are sequentially forwarded to the processing sections.

Based on the information of referred processing conditions, for example, (1) development time, (2-1) light source intensity, (2-2) CCD sensitivity, (3-1) color contamination correction parameter, and (3-2) smoothing process (PC dark) parameter are adjusted and controlled. When problems occur in such adjustment and control, said processing conditions are re-confirmed and further adjustment-controlled.

When adjustment and control of said processing conditions are finished and preparation for the processing is finished, the necessary time for processing as well as image quality setting is displayed.

When adjustment is again required based on the displayed contents, a parameter adjustment menu is displayed. Subsequently, based on the resultant display, parameter data are inputted. Subsequently, after referring to the processing condition database, various types of processing conditions are re-adjusted and re-controlled.

When no problems are found in the displayed contents, processing is executed.

Based on the processing execution order, development in the development device, image reading in the image reading device, image processing in the image data processing device, and media writing in the media writing device are successively carried out, and then processing ends.

In order to more specifically describe the processing steps described with reference to the flow diagram of FIG. 1, processing employing the thermal development apparatus shown in FIG. 2 will now be described. Incidentally, in the present invention, the image forming apparatus is not limited to the thermal development apparatus shown in FIG. 2, and the development means are not limited to thermal development

FIG. 2 shows one example in which in the development process, thermal development is carried out on a thermal development drum, employing processing sheet 301 (being a processing member). Light-sensitive material F is conveyed from film insertion unit 400 to facing section 404 with processing sheet 310 via film leading edge unwinding unit 401.

Further, a processing liquid (being a color developer) supplied by processing liquid cartridge 107 of the processing liquid supply section is applied onto said processing sheet 301 supplied from processing sheet feed roll 300 via processing liquid supply nozzle 108. Thereafter, by facing said processing sheet 301 with said light-sensitive material F at facing section 404, said developer is supplied onto said light-sensitive material F.

In the example described above, it is preferable to employ a method for preparing a processing liquid in such a manner that a color developer in an inactive state is sealed in processing liquid cartridge 107 and by allowing said processing liquid to react with chemical substances previously coated onto processing sheet 301, an active state is created.

When such a method is employed, it is possible to enhance the storage stability of the processing liquid in processing liquid cartridge 107.

Further, in FIG. 2, thermal development is carried out by facing light-sensitive material F with processing sheet 301. In order to carry out uniform temperature control, it is preferable to employ a drum belt type thermal development apparatus as shown in FIG. 2.

Namely, endless belt 304 is brought into pressure contact with thermal development drum 302 in heat insulating box 303. Light-sensitive martial F is brought into contact (heat conduction) with heating drum 302 and conveyed while being pressed by said endless belt 304; is peeled off by peeling claw 405; and subsequently cooled (heat conduction) by cooling roller 406. Thereafter, reading is carried out employing film scanner 30.

During thermal development in said heat insulating box 303, CPU 126 adjusts the rotational speed of endless belt 304 via rotational speed control section 127, employing the kinds of information which have been obtained by reading light-sensitive material F inserted into film Insertion unit 400, employing bar code reader 125, and subsequently controls thermal development.

In FIG. 2, light-sensitive material F, which has been subjected to the aforesaid processing (development process), is subsequently read employing film scanner 30 (for example, RX-II, manufactured by Konica Corporation) and is transmitted to a personal computer (for example, FMV-DESK POWER TII20D, supplemented with RAM 128M, manufactured by Fujitsu), employing SCSI (for example, AHA-2940AU, manufactured by Adaptec Co.) as an interface. The obtained digital information is subjected to image processing and can be outputted employing printers such as an ink jet printer (for example, PM-800C, manufactured by Seiko Epson Co.).

While reading of image information employing film scanner 30, CPU 126 adjusts image reading conditions via film scanner control section 128, employing the identification information read from light-sensitive material F inserted into film insertion unit 400, employing bar code reader 125.

Image information read by film scanner 30 is transmitted to image processing section 118 through a data cable. Subsequently, the resultant information is stored on recording media such as MO121 and CD-R122 via media writing unit 119 and/or stored in server 123 through Internet 120. During this operation, CPU 126 adjusts the correction parameters for correcting color contamination (cross-talk) among blue, green, and red image information via image processing section 118.

Incidentally, said data cable 124 may be either wireless or hardwired.

Film scanner 30, which exhibits higher sensitivity than usual, is preferably employed. Listed as one preferable example is a film scanner employing area CCD. Further, light sources, having relatively high intensity, are preferred and other than LED, halogen lamps and metal halide lamps are preferably employed.

Incidentally, in FIG. 2, numeral 50 is a transport roller, 402 is a brush for removing dust on film F, 403 is a processing sheet, 301 is a cutter, 407 is an accumulation roller, and 4 is a winding cartridge of film F which has been developed and read.

Incidentally, in FIG. 2, an embodiment may be employed in which in the development process, the processing liquid as well as the processing sheet is replaced every time a new film strip is processed. Namely, instead of processing cartridge 107 and processing sheet roll 300 shown in FIG. 2, a constitution comprised of a processing sheet cartridge as well as a processing liquid cartridges can be employed. For example, said processing sheet cartridge and said processing liquid cartridge may be employed in an integrated state. By employing such a cartridge constitution, it is possible to further enhance the simplicity and convenience of the operation.

Employed as one example, as described above, may be a cartridge having a shape shown in FIG. 6 of U.S. Pat. No. 4,371,248.

In the thermal development apparatus shown in FIG. 2, processing liquid cartridge 107 may be manually replaced every time after finishing processing of one roll of color film or a system may be employed in which said cartridge is automatically replaced.

Though not shown specifically in FIG. 2, in such a constitution, it is preferable that the position, in which processing liquid cartridge 107 is installed, previously has a mechanism in which a plurality of processing liquid cartridges 107 can be installed.

Further, it is preferable that processing liquid cartridge 107 may be modified to a structure (for example, the nozzle cover is detached, and the developing solution sealing bag is broken) so that difference between the state in which a developing solution can be supplied to light-sensitive material F (being a color film) or processing sheet 301 and the prior state in which said supply becomes possible is visually and easily discriminated or may have a mechanism or a function in which when installed in the developing solution supplying position, a discrimination mark is simultaneously displayed (for example, a discrimination mark appears on the cartridge body or discrimination mark is adhered onto the cartridge body).

On the other hand, for example, adjustment may be carried out so that a developing solution is applied onto film (F) at a layer thickness of approximately 100 μm, employing a sponge roller into which said developing solution is incorporated.

### EFFECTS OF THE INVENTION

The present invention can provide an image forming apparatus which exhibits excellent convenience for customers while reducing environmental pollution and limitations for shops as well as processing time.

What is claimed is:

1. An image forming apparatus to obtain a digital image data, comprising:
developing device to give a color development to silver halide color photographic light sensitive material and to form a dye image on the light sensitive material;
image reading device reading the dye image to obtain a dye image information, converting the dye image information to electronic signals via a image imputing medium and forming a digital image data from the electronic signals;
image data processing device to give a image data processing to the digital image data; and
identifying device to obtain an identification information of the light sensitive material,
wherein an image reading condition in the image reading device is adjusted in accordance with the identification information.

2. The image forming apparatus of claim 1, wherein a developing condition in the developing device is further adjusted in accordance with the identification information.

3. The image forming apparatus of claim 1, wherein an image data processing condition is further adjusted in accordance with the identification information.

4. The image forming apparatus of claim 2, wherein an image data processing condition is further adjusted in accordance with the identification information.

5. The image forming apparatus of claim 2, wherein the image reading condition is at least one of an intensity of a light source, which is used to read the dye image, a spectral distribution characteristic, a sensitivity of the image input medium or a reading time.

6. The image forming apparatus of claim 2, wherein the developing condition is a developing time.

7. The image forming apparatus of claim 3, wherein the image data processing condition is a correction parameter to correct the color contamination among Red, Green and Blue in the digital image data.

8. The image forming apparatus of claim 6, wherein the image data processing condition is a correction parameter to correct the color contamination among Red, Green and Blue in the digital image data.

9. The image forming apparatus of claim 1, wherein the identification information is at least one of a universal commodity code printed on the surface of a film cartridge packing the light sensitive material, a trademark design printed on the surface of the film cartridge or a raster mark of the light sensitive material.

10. The image forming apparatus of claim 1, wherein the image forming apparatus have no desilvering device for desilvering the dye image obtained by the developing device.

11. The image forming apparatus of claim 1, wherein the development given by the developing device is a thermal development.

12. The image forming apparatus of claim 1, wherein the color development is given only to an exposed frame area of the light sensitive material.

13. The image forming apparatus of claim 1, wherein the image forming apparatus is a self-operation apparatus.

14. The image forming apparatus of claim 4, wherein the image forming apparatus further comprises a memory device to storage the developing condition in the developing device, the image reading condition in the image reading device and the image data processing condition in the image data processing device in the state of a code.
